(19) United States
(12) Patent Application Publication
(10) Pub. No.: US 2025/0074099 A1
(43) Pub. Date: Mar. 6, 2025

(54) BOOK HOLDER FOR ONE HANDED NATURAL PAGE TURNING OF ALL SIZED BOOKS

(71) Applicants: Daniel Beckmann, Lakeview, MI (US); John Andrew Beckmann, Lakeview, MI (US)

(72) Inventors: Daniel Beckmann, Lakeview, MI (US); John Andrew Beckmann, Lakeview, MI (US)

(21) Appl. No.: 18/821,895

(22) Filed: Aug. 30, 2024

Related U.S. Application Data
(60) Provisional application No. 63/536,486, filed on Sep. 4, 2023.

(51) Int. Cl. B42D 9/00

(52) U.S. Cl. CPC B42D 9/00

(57) ABSTRACT

One embodiment where a support holds the book, and an arm is pivotally attached to near the center of the support. It rotates the same way with a book. The arm can be releasably locked to the support. The arm is placed adjacent to the support so it can be pried open. One end of the line is attached to the distal end of the arm. The other is anchored to the opposite end of the support. The length of the line across the support can be changed. The arm can be in the open position or the closed position. An open book is sandwiched between the support and the line in the closed position.

### CROSS-REFERENCE TO RELATED APPLICATIONS

This application claims the benefit of provisional patent Application Ser. No. 63/536,486, filed September 4 by Daniel Beckmann.

### BACKGROUND—PRIOR ART

The following is a tabulation of some prior art that presently appears relevant:

U.S. Patents

| Patent Number | Issue Date | Patentee |
|---|---|---|
| U.S. Pat. No. 4,978,096A | 1990 Dec. 18 | Struckmann |
| U.S. Pat. No. 3,981,522A | 1976 Sep. 21 | Bloom |
| U.S. Pat. No. 6,045,159A | 2000 Apr. 4 | Bellah |
| U.S. Pat. No. 4,296,946A | 1981 Oct. 27 | Larre et. al |
| U.S. Pat. No. 5,709,365A | 1998 Jan. 20 | Howard |
| U.S. Pat. No. 5,114,110A | 1992 May 19 | Vohora |
| U.S. Pat. No. 5,427,414A | 1995 Jun. 27 | Fletcher et. al |
| U.S. Pat. No. 4,555,128A | 1985 Nov. 26 | White et. al |
| U.S. Pat. No. 5,829,787A | 1998 Nov. 3 | Newhouse |
| US20050098702A1 | 2009 Jul. 28 | Jones et. al |

U.S. Patent Application Publications

| Patent Number | Pub. Date | Patentee |
|---|---|---|
| US20040135051A1 | 2004 Jul. 15 | Rupnick |

Foreign Patents

| Patent Number | Pub. Date | Patentee |
|---|---|---|
| JP2014210390A | 2014 Nov. 13 | Imanishi |
| KR200431756Y1 | 2006 Nov. 24 | Sang-rae |

There have been many previous inventions showing how to hold a book open so that a reader does not need to use hands to hold it open. These inventions realized the benefits of hand free reading such as, taking notes, eating, drinking, cooking, or knitting while reading. Furthermore, it simply removes hand fatigue from holding a book for an extended time.

Some inventors have acknowledged the annoyance resulting from the difficulty and lengthy process it takes to remove the page holding mechanism, turn the page, and re-engage the page holding mechanism especially repeated thousands of times. Many inventors have attempted to simplify and quicken these 3 steps, but they still have many time-consuming, halting, and unnatural movements to accomplish them.

The most well known and commercially common book stand that holds open a book includes utilizing two flexible metal tabs to press down both sides of an open book. This has around 7 individual steps to simply unlock the page holding mechanism, turn the page and reengage the page holding mechanism. This takes time. Hands need to stop and start often. Hands go in directions unnatural to turning a page. Furthermore, pages cannot be turned with one hand.

U.S. Pat. Nos. 4,296,946A, 5,709,365A, 5,427,414A, and others opted for a strap to be transversely placed across the book to hold it open. However, these along with others still have many extra movements to accomplish the 3 steps.

U.S. Pat. Nos. 3,981,522A and 6,045,159A cannot accommodate different thickness books or different binding resilience books. The pages normally cannot be turned with one hand. They normally have an extra 2 steps in turning a page. They are limited on methods of propping up the book.

U.S. Pat. Nos. 4,978,096A, 5,114,110A, 4,555,128A, JP2014210390A, and KR200431756Y1 have a short lifespan due to rubbing with the page. They ruin the edges of books due to rubbing. The pages normally cannot be turned with one hand. They normally have an extra 2 steps in turning a page. Readers are prone to accidentally tear the pages.

As can be seen, there have been many attempts to make better book stands but there still remains a need for a more user-friendly book stand.

### BRIEF SUMMARY

In accordance with one embodiment a book holder comprising a support to hold a book, a line that is attached to an arm, which is placed adjacent to the support, and can change its length across the front of the book.

### Advantages

Accordingly several advantages of one or more aspects are as follows: to immediately, seamlessly, and naturally turn the page, to accommodate any sized thickness book, to turn a page with one hand, to not damage pages, to increase the lines life, to conveniently provide extra line once the line breaks, to flatten the pages out so words on the center of any book are normal to readers view, to read in a strong wind, to hold a book that is upside down. Other advantages of one or more aspects will be apparent from consideration of the drawings and ensuing description.

### DRAWINGS—FIGURES

FIG. 1 Shows an isometric view of an exploded drawing of one embodiment.

FIG. 2 Shows an isometric view of an embodiment with the arm in the closed position.

FIG. 3 Shows an isometric view of an embodiment with the arm in the open position.

FIG. 4A Shows a left sided view of the S tensioner rotated 90 degrees so it can be pulled from the S tensioner bay.

FIG. 4B Shows a left sided view of the S tensioner locked in the S tensioner bay.

FIG. 4C Shows a front view of extra line stored on the S tensioner Rod.

FIG. 4D Shows a front view of the S tensioner locked in the S tensioner bay.

FIG. 5 Shows the back of an embodiment.

FIG. 6 Shows the back of a different embodiment and how it adjusts the lines length.

FIG. 7A Shows a front view of a hand prying open the arm.

FIG. 7B Shows a front view of a hand turning a page.

FIG. 7C Shows a hand clamping the arm closed.

### DETAILED DESCRIPTION OF THE EMBODIMENTS

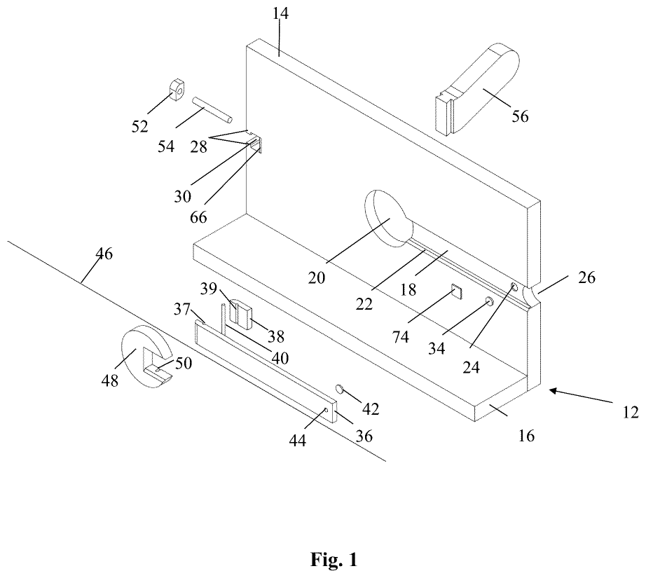

One embodiment of the book holder 10 is illustrated in FIGS. 1-5. The book holder 10 has a support 12 composed of a back support 14 and a ledge 16. The ledge 16 is attached to the bottom of the back support 14. This allows the book 72 to be held without sliding downwards or falling over. The ledge 16 also can assist stabilizing the book when it is held upside down for readers lying on their back. By moving or angling the support 12 a reader can adjust the book 72 to read at the preferred position or angle, thus reducing straining in their neck, limit fatigue from holding the book 72, or other reasons.

The back support 14 may be made from wood and carved out on a cnc router. The cnc router could create the Oval Recess 20, the Arm funnel 22, back support magnet recess 24, indentation 26, rounded edge 66, S Tensioner Bay 30, and S tensioner retainer 28. These cut outs are shown in FIG. 1. Creating all these features at once on the back support 14 significantly increases production speeds. Each one of these features has a purpose.

The Oval Recess 20 is the negative imprint of the oval 48. This way the oval 48 can fit flush into the back support 14. The arm channel 18 is the negative imprint of the arm. This allows the arm to sit flush into the back support 14. This is beneficial because it keeps one side of the book 72 from being tilted while resting, and it allows the reader to slide the book in between the support 12 and the line 46. The back support magnet recess 24 is also the negative imprint for a magnet. This helps the back support magnet 34 stay in place, so it doesn't get scraped out.

The Arm funnel 22 is an angled cut out relative to the front surface of the back support 14 and the arm channel 18. The purpose of this is to allow for the arm 36 to be funneled into the arm channel 18 while closing. Since it is difficult to manufacture a cheap pivoting mechanism that will allow for the arm to rotate exactly on a normal axis to the bottom or top surface of the arm channel 18, the arm will likely snag on the back support 14 unless if it was funneled in.

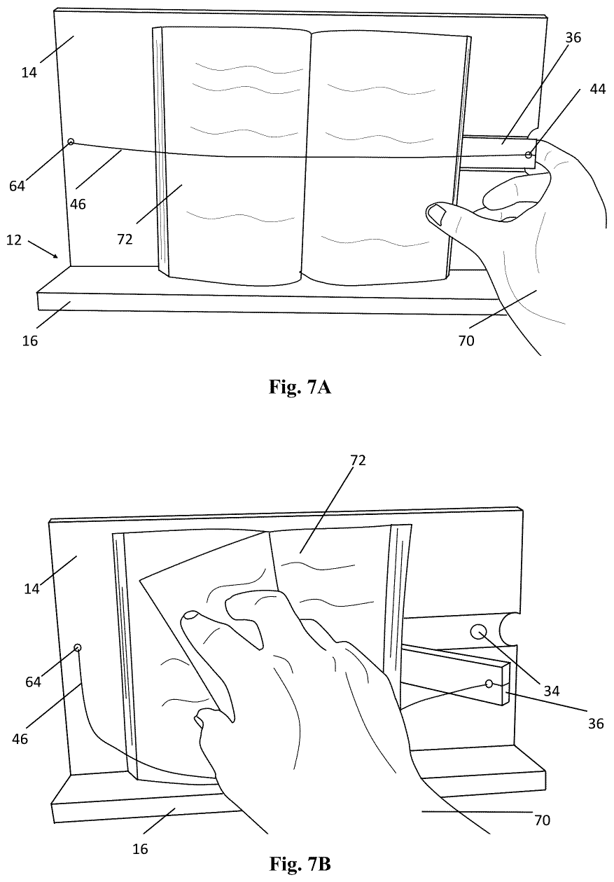

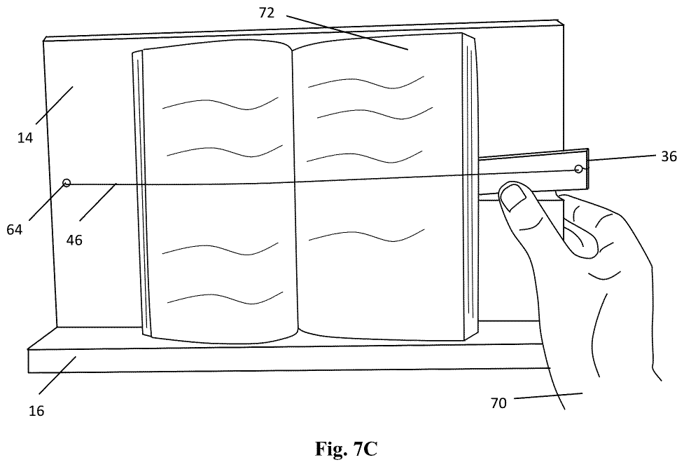

The Indentation 26 is a cut out of the support 12 directly behind the distal end of the arm 36. This is useful because it allows the reader to easily pry open the arm 36. The readers index finger can be place behind the arm 36 while the other three digits can be placed below the arm 36 to pry it open as shown in FIG. 7A. The Indentation 26 is also beneficial because it keeps the arm 36 from hanging over the end of the support 12, which exposes the arm to damage if the book holder 10 is dropped and reduces the possibility of the arm 36 breaking through the packaging during shipping to customers.

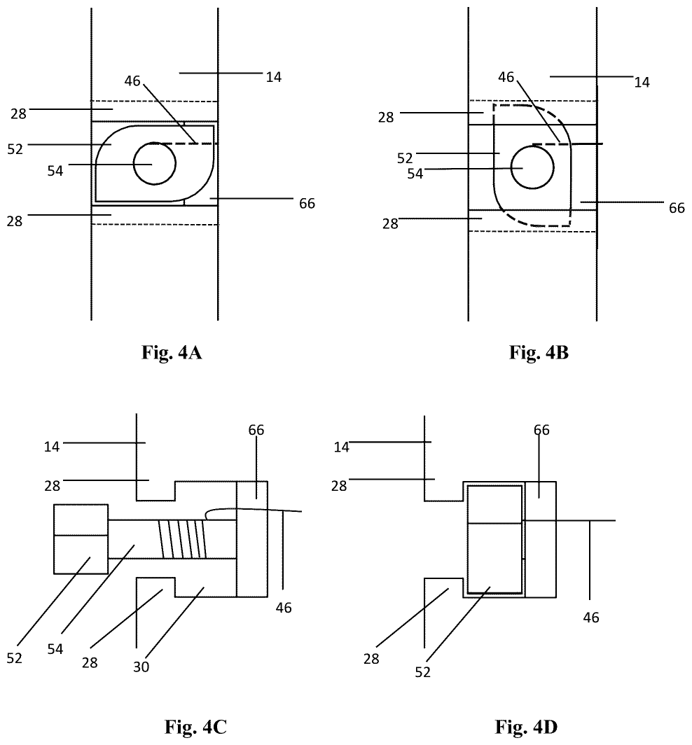

The way of changing the length of the line 46 and storing extra line 46 for one embodiment is shown in FIG. 4. The S tensioner bay 30 is a place that the S tensioner 52 is held. It also prevents the S tensioner 52 from completely rotating thus releasing tension in the line 46.

The S tensioner Retainer 28 is two overhangs that retain the S tensioner 52 in place but allows the S tensioner 52 to release if it is rotated counterclockwise 90 degrees. The benefit of it being retained in place is so that it doesn't fall out. It would fall out even when there is tension in the string because if the line 46 was wrapped around the medial end of the S tensioner rod 54, the tension from the line 46 will be directed laterally because the line is bent 180 degrees around the rounded edge 66.

The S tensioner rod recess 32 is the place where the S tensioner rod 54 fits in and pivots. The line 46 is attached then wrapped around the S tensioner rod 54 and is stored in the S tensioner rod recess 32. The extra line is stored for when it breaks. The line could be made stronger to prevent more breakages, but then it will visually interfere with reading the book. The S tensioner Rod recess 32 also prevents the line 46 from uncoiling when its tension is released. This prevents it from getting tangled up and falling off. It stores it in a neat orderly manner.

The S tensioner 52 and the S tensioner Rod 54 are glued together. The line 46 is wrapped around the S tensioner rod 54 clockwise hence when there is tension in the line 46 it rotates the S tensioner 52 and S tensioner rod 54 clockwise. This locks the S tensioner 52 in the S tensioner bay 30 by the S tensioner retainer 54. To release the S tensioner 52 and S tensioner rod 54 the reader needs to rotate them 90 degrees counterclockwise and pull them distally. Then the reader can adjust the length of the line 46 to accommodate any sized thickness book 72, adjust the tension in the string to accommodate for stronger or softer winds or book bindings, make the book 72 lie flatter, or to release extra line 46 once the line has broken, instead of searching for or buying new line. It is recommended to have the line storing mechanism and length changing means to be combined because it cuts down on manufacturing costs, solves two problems simultaneously, and the line 46 only needs to be re-attached in one place.

The cylinder pivot 40 is sandwiched between the arm valley 37 and the arm tab valley 39 shown in FIG. 1. The cylinder pivot 40 is longer than the width of the arm 36 so that it protrudes out forming a pivoting surface. It is preferably made of metal for strength, specifically aluminum to avoid rust. Some benefits of having the arm tab 38 is being able to create a straighter hole for the cylinder pivot 40 to fit into, and it is much easier to manufacture. If the arm 36 was made from one part the hole for the cylinder pivot would need to be drilled out, meaning the drill will walk a little since the hole size is relatively small, meaning the hole will not be normal with the top and bottom surface of the arm, meaning the arm will not rotate straight, meaning the arm will snag with the support 12 or oval 48 and provide an unsmooth and encumbered rotation of the arm 36. The oval cylinder pivot recess 50 is a valley instead of a hole drilled through the top for the same reason.

The Cylinder pivot 40 is then placed in the oval cylinder pivot recess 50, then the oval 48 and the arm 36 are placed in their respective recesses in the back support 14. The oval 48 is then attached to the back support 14 through screws. The determined position of the bottom of the arm 36 is placed around 2 or more inches on top of the ledge 16. This allows for readers to place their fifth, fourth, and third digit on their hand 70 underneath the arm touching the back support 14 as shown in FIG. 7A. This makes it easier for the hand 70 that just pried open the arm 36 to slide towards the book to grab it. This also allows for a natural hand position to pry open the arm 36 and place thumb on the book or arm as shown in FIG. 7A The benefit of placing the thumb on the arm 36 or book 72 is so that the book 72 will not spring closed once the magnet is released.

The arm 36 has an arm anchoring hole 44 drilled through it at the distal end where the line 46 is tied to. The arm 36 also has a recess where the arm magnet is glued into. The arm magnet and the back support magnet 34 should be located so that they are lined up when they are in the closed position.

A sound cushion 74 is sandwiched between the arm 36 and the back support 14 so that when the arm 36 is shut it doesn't make a loud noise, disturbing the reader or other people that are around such as in a library.

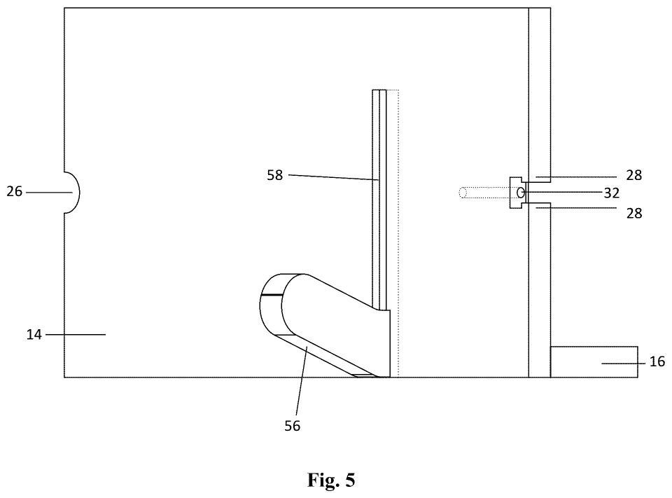

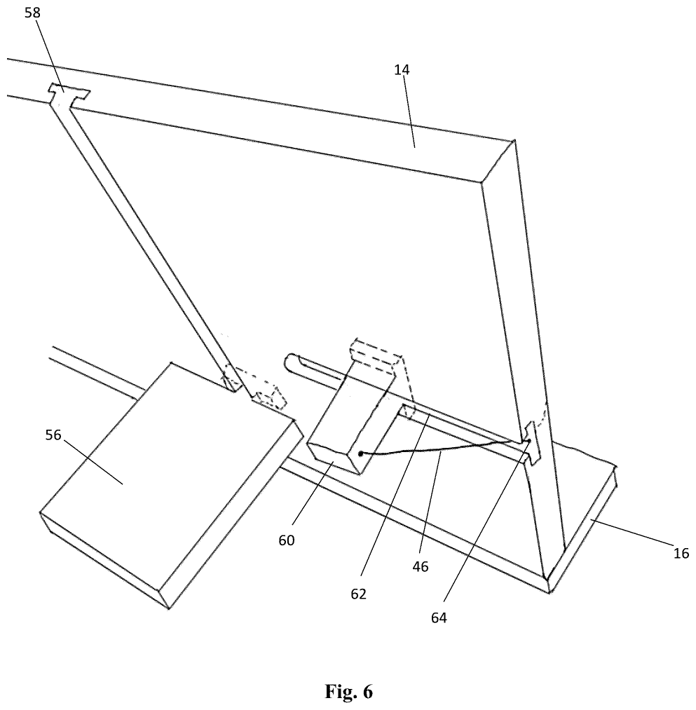

The support 12 has a prop channel 58 that runs up and down on the back as shown in FIG. 5. A prop 56 has an end with the same outline as the prop channel 58 but slightly smaller so that it can fit into the prop channel 58. By sliding the prop 56 up and down a reader can change the angle that the book 72 is held at. The prop 56 doesn't slide in the prop channel 58 when the support 12 is resting on it because it creates a moment in the prop 56 which causes two normal forces between the support 12 and prop 56, which increases the friction. The prop 56 in FIG. 5 is angled upwards which creates a larger normal force which increases the friction to guarantee the prop wont slip. This provides a cheap prop which allows for a quick way to adjust the angle during use.

### Operation

To operate an embodiment a reader may increase the length of the line 46 to roughly the length that the book 72 will assuredly be able to fit into. This is accomplished by rotating the S tensioner 52 90 degrees counterclockwise then pulling it out of the S tensioner bay 30. Then the reader will rotate the S tensioner 52 clockwise thus releasing extra line 46. The reader will then rotate the S tensioner 52 so it can fit back into the S tensioner bay 30.

The reader will slide an open book 70 in between the front of the back support 14 and the line 46. The reader can then adjust the tension in the same manner previously discussed. This allows the embodiment to accommodate the thickness of the book 72.

To turn the page a reader can place their index finger behind the arm 36 and in the indentation 26, the thumb over the front of the book 72, and the other three fingers beneath the arm 36 and in front of the back support 14. Then use the fingers to pry open the arm 36 to release the magnets. This is accomplished by pulling the arm forwards with the index finger and pushing the support 12 back with the other three fingers. Without the ability to pry open the arm 36, the entire book holder 10 will pivot without opening the arm 36. This problem is exemplified with thinner book holders and lightweight book holders which are placed on smooth surfaces such as a table. If the magnet strengths were decreased by a lot to remove this problem the book 72 would close on its own and it would not be able to flatten the book down so the pages are normal to the viewers line of sight. By placing the thumb over the book 72 or arm 36 it stops the book from springing closed once the magnets are released as shown in FIG. 7A. This could be annoying losing your place in a book every time the page is turned.

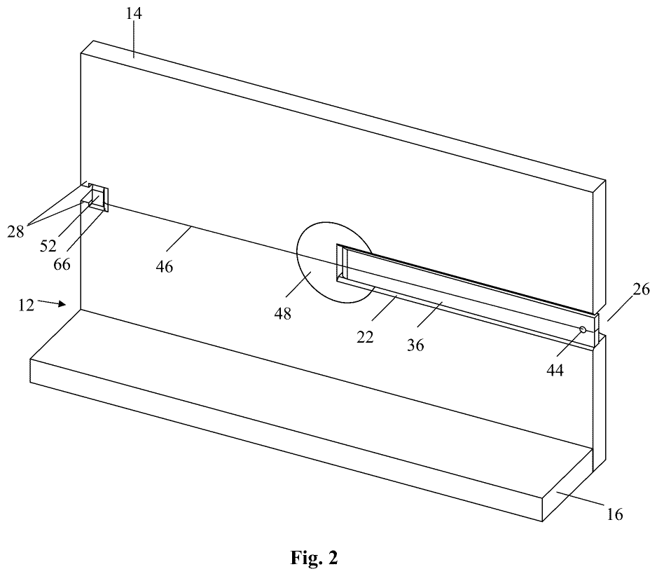

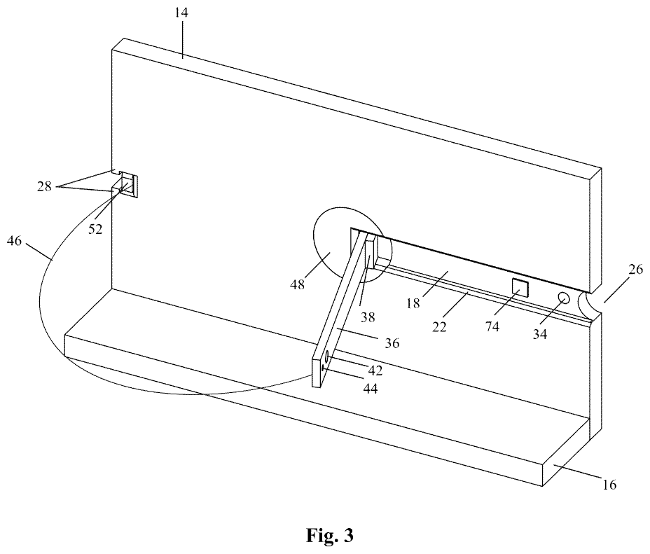

Once the magnets are released the reader brings the arm 36 from the closed position shown in FIG. 2 to the open position shown in FIG. 3. To be in the determined open position the arm 36 needs to be opened wide enough to allow for the page to turn without rubbing on the line 46 while it is still taught. Next the reader will let go of the arm 36 and grab the page that needs to be turned with the same hand 70. The arm 36 will not spring back to the closed position so that the line 46 will not be taught over the book or the reader will not need to hold the arm open while turning the page. The page being turned is shown in FIG. 7B. Once the page is turned the arm 36 is brought to the closed position by clamping it closed as shown in FIG. 7C. It should be noted that when the book 72 is held open the book holder 10 is in the closed position as shown in FIG. 2. while when the book 72 is partially closed the book holder 10 is in the open position as shown in FIG. 3.

The reader can slide the prop 56 up and down within the prop channel 58 to adjust the angle which the book is read at.

### Alternative Embodiments

Another embodiment is shown in FIGS. 6-7. This embodiment has a different method of changing the length of the line 46 across the front of the support 12. The one end of the line 46 is fed through the slider tensioner back support hole 64 and then anchored to the slider tensioner 60 at the end farthest away from the back support 14 so that the tension in the line 46 will create a moment in the Slider tensioner 60 to increase the friction with the Slider tensioner channel 62. The slider tensioner 60 then can be slid in the slider tensioner channel 62 to adjust the length of the line 46 across the back support 14.

The flexible elongated member can be construed to include but not limited to, a line, a rope, a string, a strap, a wire, a cable, a chain, a monofilament, or a thread.

There are different ways to store the line 46. It could be stored in a container hollowed out from the support 12. Storing the extra line 46 does not need to be combined with the means to change the lines length even though it is recommended.

The book holder 10 can have holes drilled into it to store pencils. The book holder 10 can have a light attached to it for reading in the dark.

The means for changing the length of the line 46 across the front of the support 12 can be construed to include but not limited to; the line 46 running through a cord lock attached to the support, the line 46 attached to a peg with different slots in the support 12 for the peg to fit into, the line 46 wrapped around a wheel that only rotates when selected to, the line 46 being attached to a spring, or being elastic, or the line having a loop at the end that can be grabbed by hooks.

The book holder 10 can have multiple lines 46 running across the front of the support 12 to help keep the edges of the books from flapping in the wind.

The support 12 is preferably made from wood, plastic or metal. The support 12 preferably supports a book using a back support 14 and a ledge 16. The ledge 16 can pivot to reduce space during transit in a backpack. A different embodiment may include multiple clamps to hold down the left cover, or a back support 14 having two straps on the left side that lock the left cover of the book in place.

The Arm funnel 22 can have the angled cut out on the arm or the back support 14.

There can be multiple mechanisms to adjust the angle and location of the book holder 10 such as a bean bag, which will not work for other people inventions, or a stiff but flexible rod attached to the back of the support 12.

A locking mechanism can be construed to include but is not limited to a hook and loop fabric, magnets, magnets and iron, adhesive, suction cup, friction between support 12 and arm 36, a spring between support 12 and arm 36, latch, button snaps, and other locking mechanisms meant to hold the arm in the closed position.

The arm can be pivotally attached to the support 12 in multiple ways including but not limited to, a compliant mechanism, bendable cloth, door hinge, and ball and socket joints.

The line 46 can be anchored to the arm 36 in multiple ways including tying or gluing.

The line 46 can be anchored to the arm 36 in many ways. It normally will be attached to a length changing mechanism which will be anchored to the support 12.

The rounded edge 66 is used to negate high localized stress on corners in the line while rubbing along the edge. A smooth plastic surface could be placed over it to also increase the lines 46 life.

1. A book holder comprising a support, an arm being pivotally attached to said support, a locking mechanism configured to releasably lock said arm to said support, a flexible elongated member anchored to the approximate distal side of said arm, said flexible elongated member anchored to near the distal side of said support on the opposite side of said arm, and a means for changing length of said flexible elongated member across the front of said support, whereby a page of a book of any sized thickness can be quickly turned without damaging said book and increasing said flexible elongated members life.

2. The book holder of claim 1 wherein said means for changing length of said flexible elongated member across the front of said support stores extra flexible elongated member for when said flexible elongated member breaks.

3. The book holder of claim 1 wherein the edge of said support is rounded where it interacts with said flexible elongated member to increase said flexible elongated member's life.

4. A book holder comprising, a support, an arm being pivotally attached to said support, a locking mechanism configured to releasably lock said arm to said support, said arm being adjacent to said support wherein a reader can pry open with a hand said arm with respect to said support, a flexible elongated member anchored to the approximate distal side of said arm, said flexible elongated member anchored to near the distal side of said support on the opposite side of said arm.

5. The book holder of claim 4 wherein a sound cushion is sandwiched between said support and said arm to dampen noise while closing said arm.

6. The book holder of claim 4 wherein the bottom of said arm is at a predetermined height on support to allow for natural hand placement while prying.

7. The book holder of claim 4 wherein said support has an indentation behind the distal end of said arm.

8. The book holder of claim 4 wherein said arm is recessed into said support whereby a book can be slid in between said support and said flexible elongated member and said book is not tilted.

9. The book holder of claim 4 wherein a funnel occurs between said support and said arm.

10. The book holder of claim 4 wherein said arm can be rotated with a torque under 20 inch pounds.

11. The book holder of claim 4 wherein a cylindrical pivot is sandwich between said arm and an arm tab.

12. The book holder of claim 4 wherein said locking mechanism is composed of a plurality of magnets.

13. A method of holding a book open while still allowing natural turning of a page comprising:
(a) Providing a book holder comprising a support, an arm being pivotally attached to said support, a locking mechanism configured to releasably lock said arm to said support, a flexible elongated member being anchored to said arm and said support, and a means for changing length of said flexible elongated member across the front of said support,
(b) Locking said arm to said support by employing said locking mechanism
(c) Sandwiching said book between said support and said flexible elongated member to hold book open
(d) Adjusting said flexible elongated members length to accommodate any sized thickness book
(e) Prying said arm away from said support with a hand
(f) Rotating said arm and said book to a predetermined open position
(g) Releasing said hand from said arm
(h) Grabbing said page and turning it.

14. The method of claim 13 wherein said flexible elongated member is transparent.

15. The method of claim 13 wherein said book holder stores extra said flexible elongated member.

16. The method of claim 3 wherein said arm can be rotated with a torque under 20 inch pounds.

17. The method of claim 3, further including placing a thumb on said page or in front of said arm before releasing said locking mechanism, whereby said book will not spring closed when said locking mechanism is released.

18. The method of claim 3, further including adjusting the angle of the support.

19. The method of claim 3, wherein said arm is at a predetermined height on support to allow for natural hand placement while prying.
